(19) United States
(12) Patent Application Publication
(10) Pub. No.: US 2026/0302021 A1
(43) Pub. Date: Oct. 1, 2026

(54) MAGNETIC MATERIAL, MAGNETIC FLUID, STANDARD SAMPLE FOR PARTICLE SIZE DISTRIBUTION MEASUREMENT, METHOD FOR PRODUCING A MAGNETIC MATERIAL AND METHOD FOR PRODUCING A MAGNETIC FLUID

(71) Applicants: SOMAR CORPORATION, Tokyo (JP); TOKYO METROPOLITAN INDUSTRIAL TECHNOLOGY RESEARCH INSTITUTE, Tokyo (JP)

(72) Inventors: Hirohisa ISHIZAKI, Tokyo (JP); Akira OCHIAI, Tokyo (JP); Shohan YANAGI, Tokyo (JP)

(73) Assignees: SOMAR CORPORATION, Tokyo (JP); TOKYO METROPOLITAN INDUSTRIAL TECHNOLOGY RESEARCH INSTITUTE, Tokyo (JP)

(21) Appl. No.: 19/576,235

(22) Filed: Mar. 24, 2026

(30) Foreign Application Priority Data
Mar. 27, 2025 (JP) 2025-054322

(51) Int. Cl. H01F 1/44; B82Y 25/00; B82Y 40/00

(52) U.S. Cl. CPC H01F 1/44; B82Y 25/00; B82Y 40/00

(57) ABSTRACT

To provide a magnetic material, magnetic fluid, standard sample for particle size distribution measurement, method for producing a magnetic material and method for producing a magnetic fluid that solves the storage and safety issues of polar organic solvent-based magnetic fluids and effectively suppresses the generation of secondary particles of magnetic particles in magnetic fluids even when a polar organic solvent is added to a magnetic material obtained by removing the dispersion media from a first magnetic fluid to form a second magnetic fluid. A magnetic material comprising magnetic particles having an average particle size of 10 to 50 nm, a saturated fatty acid or a salt thereof, or an unsaturated fatty acid or a salt thereof, having 10 to 24 carbon atoms, and an alkoxylate formed by addition of an alkylene oxide having 2 to 4 carbon atoms to an alcohol having 1 to 3 carbon atoms.

### FIELD OF THE INVENTION

The present invention relates to a magnetic material, magnetic fluid, standard sample for particle size distribution measurement, method for producing a magnetic material and method for producing a magnetic fluid.

### BACKGROUND OF THE INVENTION

In recent years, magnetic fluids have attracted attention as a hysteresis-free magnetic material suitable for use in magnetic cores, rectifiers, current sensors, and other devices (see, for example, Patent Literature 1). Magnetic fluids are magnetic materials that exhibit superparamagnetic properties by dispersing magnetic powders, such as ferrite or magnetite particles, with particle sizes ranging from 3 to 50 nm, in a dispersion media. To achieve superparamagnetic properties, the magnetic particles must be nanometer-sized. Furthermore, polar organic solvents, such as water, hydrocarbon oils, and alcohols, are commonly used as dispersion media.

In addition, to homogeneously disperse nanometer-sized magnetic particles in a dispersion media, at least a portion of the magnetic particle surface is typically coated with a dispersant selected from surfactants (e.g., sodium oleate). For example, Patent Literature 2 discloses an alcohol-based magnetic fluid containing alcohol, a surfactant, a liquid crystal compound that is liquid at a predetermined temperature, and magnetic metal oxide and/or magnetic metal particles. Also examples in which polyoxyethylene nonylphenyl ether is used as the surfactant, a cyanobiphenyl-based liquid crystal compound is used as the liquid crystal compound, and magnetite is used as the magnetic metal compound, are disclosed.

### CITATION LIST

### Patent Literatures

[Patent Literature 1] WO 2010/041340
[Patent Literature 2] Japanese Unexamined Patent Application Publication No. 9-40983

### SUMMARY OF THE INVENTION

However, magnetic fluids based on alcohol or other polar organic solvents require safety considerations during storage and transportation. One solution to this problem is to remove some or all of the polar organic solvent from the magnetic fluid and convert it into a magnetic powder. However, this method results in the magnetic nanoparticles agglomerating and forming secondary particles. Because magnetic nanoparticles strongly aggregate, even if a polar organic solvent is added to the magnetic powder to restore the magnetic fluid to its original state before the organic solvent is removed, the magnetic nanoparticles do not revert to primary particles but remain as secondary particles, resulting in hysteresis. This makes their use in magnetic cores, rectifiers, current sensors, and other applications difficult. Therefore, there is a need for a magnetic fluid that suppresses the generation of secondary particles from magnetic nanoparticles, even when the organic solvent is added again to the magnetic material obtained by removing the organic solvent from the magnetic fluid and then converting it into a magnetic fluid.

Meanwhile, the particle size measurement results of nanoparticles dispersed in a liquid depend on the measurement principle and conditions. Therefore, standard samples are used to evaluate the validity of nanoparticle size measurements. Standard samples are required to be similar to the target specimen. However, commercially available standard samples for nanoparticle measurement are aqueous dispersions of organic or metal nanoparticles, and no polar organic solvent-based standard samples are available that can be diluted to any desired concentration. Furthermore, when using a polar organic solvent-based dispersion of magnetic nanoparticles as a standard sample, precise control of an iron oxide particle size and excellent dispersion stability are required. However, until now, insufficient development and research on magnetic nanoparticle standard samples have been conducted. Therefore, if a magnetic fluid could be developed that suppresses the generation of secondary particles of magnetic nanoparticles even when a polar organic solvent is added again to the composition obtained by removing the polar organic solvent from the magnetic fluid to form a magnetic fluid, it could be used as a standard sample.

The present invention addresses these issues and aims to provide a magnetic material, magnetic fluid, standard sample for particle size distribution measurement, method for producing a magnetic material and method for producing a magnetic fluid that solves the storage and safety issues of polar organic solvent-based magnetic fluids and effectively suppresses the generation of secondary particles of magnetic particles in magnetic fluids even when a polar organic solvent is added to a magnetic material obtained by removing the dispersion media from a first magnetic fluid to form a second magnetic fluid.

In order to solve the above problems, the present invention is specified as follows [1] to [7].
[1] A magnetic material comprising:
magnetic particles having an average particle size of 10 to 50 nm,
a saturated fatty acid or a salt thereof, or an unsaturated fatty acid or a salt thereof, having 10 to 24 carbon atoms, and
an alkoxylate formed by addition of an alkylene oxide having 2 to 4 carbon atoms to an alcohol having 1 to 3 carbon atoms.
[2] The magnetic material according to [1], being in paste form.
[3] A magnetic fluid comprising:
the magnetic material according to [1] or [2], and
a polar organic solvent.
[4] A standard sample for particle size distribution measurement, comprising:
the magnetic material according to [1] or [2], and
a polar organic solvent,
wherein a content of the magnetic particles is 0.5 to 3 mass %.
[5] A method for producing a magnetic material, comprising:
removing the polar organic solvent from the magnetic fluid according to [3] to obtain a magnetic material,
wherein a content of the polar organic solvent in the magnetic material obtained after removing the polar organic solvent is 1 mass % or less.
[6] A method for producing a magnetic material, comprising:
obtaining a first magnetic fluid containing magnetic particles, a saturated fatty acid or a salt thereof, or an unsaturated fatty acid or a salt thereof, having 10 to 24 carbon atoms, and water or a non-polar solvent,
mixing an alkoxylate formed by addition of an alkylene oxide having 2 to 4 carbon atoms to an alcohol having 1 to 3 carbon atoms with the first magnetic fluid, and
removing the water or the non-polar solvent.
[7] A method for producing a magnetic fluid, comprising:
mixing a polar organic solvent with the magnetic material obtained by the production method according to [6] to obtain a second magnetic fluid.

According to the embodiments of the present invention, it is possible to provide a magnetic material, magnetic fluid, standard sample for particle size distribution measurement, method for producing a magnetic material and method for producing a magnetic fluid that solves the storage and safety issues of polar organic solvent-based magnetic fluids and effectively suppresses the generation of secondary particles of magnetic particles in magnetic fluids even when a polar organic solvent is added to a magnetic material obtained by removing the dispersion media from a first magnetic fluid to form a second magnetic fluid.

### BRIEF DESCRIPTION OF THE DRAWINGS

FIG. 1 is a result of measuring a particle size distribution of magnetic particles of a standard sample for particle size distribution measurement of Example 7.

FIG. 2 is a result of measuring a particle size distribution of magnetic particles of a standard sample for particle size distribution measurement of Comparative Example 14.

### DETAILED DESCRIPTION OF THE INVENTION

Below, we will explain embodiments of a magnetic material, magnetic fluid, standard sample for particle size distribution measurement, method for producing a magnetic material and method for producing a magnetic fluid of the present invention, but the present invention should not be interpreted as being limited to these, and various changes, modifications, and improvements can be made based on the knowledge of those skilled in the art as long as they do not deviate from the scope of the present invention.

In this specification, the use of “to” to represent a numerical range indicates a range that includes the numerical values respectively stated as the upper and lower limits. Furthermore, when a unit is stated for only the upper limit of a numerical range, this means that the lower limit is also expressed in the same unit as the upper limit.

In the specification of numerical ranges stated in stages, the upper or lower limit stated in a certain numerical range may be replaced with the upper or lower limit of another numerical range stated in stages.

In the specification of numerical ranges stated in stages, the upper or lower limit stated in a certain numerical range may be replaced with a value shown in the examples.

In this specification, when the composition contains multiple substances corresponding to each component, the content or amount of each component in a composition means the total content or amount of those multiple substances present in the composition, unless otherwise specified.

### (Magnetic Material)

The magnetic material according to this embodiment comprises magnetic particles having an average particle size of 10 to 50 nm, a saturated fatty acid or a salt thereof, or an unsaturated fatty acid or a salt thereof, having 10 to 24 carbon atoms, and an alkoxylate formed by addition of an alkylene oxide having 2 to 4 carbon atoms to an alcohol having 1 to 3 carbon atoms. Each component contained in the magnetic material will be explained below.

### 1. Magnetic Particles

The magnetic material according to this embodiment comprises magnetic particles. Examples of magnetic particles include ferromagnetic oxides, ferromagnetic metals, and metal nitrides. Examples of ferromagnetic oxides include magnetite (Fe₃O₄), γ-iron oxide, manganese ferrite, cobalt ferrite, or composite ferrites of these with zinc or nickel, and barium ferrite. Examples of ferromagnetic metals include iron, cobalt, and rare earth elements. Among these, magnetite is preferred as the magnetic particle from the viewpoint of mass productivity. The average particle diameter of the magnetic particles used in this embodiment is 10 to 50 nm, preferably 10 to 40 nm. One type of magnetic particle may be used alone, or two or more types may be used in combination. The shape of the magnetic particles is preferably spherical or nearly spherical, as this facilitates dispersion.

The content of the magnetic particles is preferably in the range of 45 to 85% by mass, and more preferably 55 to 75% by mass, relative to the total mass of the magnetic material.

### 2. Saturated Fatty Acid or Salt Thereof, or Unsaturated Fatty Acid or Salt Thereof, Having 10 to 24 Carbon Atoms

The magnetic material according to this embodiment comprises the saturated fatty acid or the salt thereof, or the unsaturated fatty acid or the salt thereof, having 10 to 24 carbon atoms. Examples of saturated fatty acids or the salt thereof or unsaturated fatty acids or the salt thereof, having 10 to 24 carbon atoms include saturated fatty acids or the salt thereof or unsaturated fatty acids or the salt thereof having 10 to 24 carbon atoms, such as lauric acid, myristic acid, palmitic acid, stearic acid, isostearic acid, oleic acid, linolenic acid, linoleic acid, erucic acid, arachidic acid, arachidonic acid, behenic acid, and lignoceric acid. Among these, the saturated fatty acids or the salt thereof or unsaturated fatty acids or the salt thereof, having 12 to 20 carbon atoms, such as lauric acid, myristic acid, palmitic acid, stearic acid, isostearic acid, oleic acid, linolenic acid, linoleic acid, arachidic acid, and arachidonic acid, are preferred. Among these, sodium salt of oleic acid (hereinafter sometimes referred to as sodium oleate) is particularly preferred due to its low cost and easy availability. In this specification, the saturated fatty acid or the salt thereof, or the unsaturated fatty acid or the salt thereof, having 10 to 24 carbon atoms, may be referred to as the first surfactant.

The saturated fatty acid or the salt thereof, or the unsaturated fatty acid or the salt thereof, having 10 to 24 carbon atoms, may be used alone or in combination of two or more. The total content of the saturated fatty acid or the salt thereof, or the unsaturated fatty acid or the salt thereof, having 10 to 24 carbon atoms, in the magnetic material is not particularly limited as long as it is an amount that can prevent aggregation of magnetic particles, and may be selected appropriately depending on the intended use. The content of the saturated fatty acid or the salt thereof, or the unsaturated fatty acid or the salt thereof, having 10 to 24 carbon atoms, is, for example, preferably 5 to 25 mass %, more preferably 10 to 20 mass %, relative to the total amount of the magnetic material.

### 3. Alkoxylate Formed by Addition of Alkylene Oxide Having 2 to 4 Carbon Atoms to Alcohol Having 1 to 3 Carbon Atoms

The magnetic material according to this embodiment comprises an alkoxylate formed by addition of an alkylene oxide having 2 to 4 carbon atoms to an alcohol having 1 to 3 carbon atoms. In this specification, the alkoxylate formed by addition of the alkylene oxide having 2 to 4 carbon atoms to the alcohol having 1 to 3 carbon atoms may be referred to as a second surfactant. When the magnetic material contains such a second surfactant, the second surfactant adheres to the first surfactant that is adhered to the surface of the magnetic particles. As a result, problems with storage and safety of the magnetic fluid are solved, and even when a polar organic solvent is added again to the magnetic material to form a magnetic fluid, aggregation of the magnetic particles in the magnetic fluid is effectively suppressed.

The content of the alkoxylate formed by addition of the alkylene oxide having 2 to 4 carbon atoms to the alcohol having 1 to 3 carbon atoms is preferably 10 to 30 mass %, more preferably 15 to 25 mass %, based on the total amount of the magnetic material.

Examples of the alcohols having 1 to 3 carbon atoms include methanol, ethanol, and propanol. Of these, methanol is preferred. Examples of the alkylene oxides having 2 to 4 carbon atoms include ethylene oxide, propylene oxide, 1-butene oxide, 2,3-butylene oxide, and 2-methyl-1,2-propene oxide (isobutene oxide). Of these, ethylene oxide and propylene oxide are preferred, and ethylene oxide is more preferred. The alcohols having 1 to 3 carbon atoms and the alkylene oxides having 2 to 4 carbon atoms may each be used alone or in combination of two or more. A method for producing the alkoxylate formed by addition of the alkylene oxide having 2 to 4 carbon atoms to the alcohol having 1 to 3 carbon atoms will be described later.

The magnetic material of this embodiment may further comprise a polar organic solvent, which will be described later. From the viewpoint of storage and transportation of the magnetic material, the content of the polar organic solvent relative to the total amount of the magnetic material is preferably 1% by mass or less, more preferably 0.8% by mass or less, and even more preferably 0.6% by mass or less.

The magnetic material according to this embodiment is preferably in paste form. When the content of the polar organic solvent relative to the total amount of the magnetic material is 1% by mass or less, for example, the magnetic material is preferably in paste form when the polar organic solvent is removed from the magnetic material containing the polar organic solvent. Since transporting and storing magnetic fluids containing a polar organic solvent can be dangerous, safety can be improved by removing the polar organic solvent to form a paste before transporting or storing the magnetic fluid. Furthermore, as described below, even when the magnetic fluid according to this embodiment is converted into a magnetic fluid by adding a polar organic solvent to the paste again, aggregation of magnetic particles in the magnetic fluid is suppressed, and the generation of secondary particles of the magnetic particles is effectively suppressed.

### (Method for Producing Magnetic Material)

The magnetic material according to this embodiment can be produced by preparing a first magnetic fluid, as described below, and then mixing the first magnetic fluid with the alkoxylate formed by addition of the alkylene oxide having 2 to 4 carbon atoms to the alcohol having 1 to 3 carbon atoms, and then removing the dispersion media, water or a non-polar solvent by heating or vacuum heating, for example. The water or non-polar solvent can be removed by heating to 40 to 50° C. or drying under reduced pressure, for example.

Alternatively, the magnetic material can be produced by removing the polar organic solvent from the magnetic fluid (second magnetic fluid) described below. In this case, the content of the polar organic solvent in the magnetic material is preferably 1% by mass or less, more preferably 0.8% by mass or less, and even more preferably 0.6% by mass or less.

### (Magnetic Fluid)

The magnetic fluid according to this embodiment comprises magnetic particles having an average particle size of 10 to 50 nm, a saturated fatty acid or a salt thereof, or an unsaturated fatty acid or a salt thereof, having 10 to 24 carbon atoms, an alkoxylate formed by addition of an alkylene oxide having 2 to 4 carbon atoms to an alcohol having 1 to 3 carbon atoms, and a polar organic solvent. This magnetic fluid may be referred to as a “second magnetic fluid” in this specification.

Furthermore, a magnetic fluid comprising magnetic particles having an average particle size of 10 to 50 nm, a saturated fatty acid or a salt thereof, or an unsaturated fatty acid or a salt thereof, having 10 to 24 carbon atoms, and water or a non-polar solvent may be referred to as a “first magnetic fluid” in this specification.

In the magnetic material according to this embodiment, the saturated fatty acid or the salt thereof, or the unsaturated fatty acid or the salt thereof, having 10 to 24 carbon atoms, the alkoxylate formed by addition of an alkylene oxide having 2 to 4 carbon atoms to an alcohol having 1 to 3 carbon atoms are present and adhered in this order to the surface of the magnetic particles. In this state, even when a polar organic solvent is mixed with the magnetic material to form a second magnetic fluid, aggregation of the magnetic particles in the magnetic fluid is suppressed, effectively suppressing the generation of secondary particles of the magnetic particles.

Furthermore, even when the polar organic solvent contained in the second magnetic fluid is removed and the resulting composition is added again to the polar organic solvent to form a magnetic fluid again, aggregation of the magnetic particles in the magnetic fluid is suppressed, effectively suppressing the generation of secondary particles of the magnetic particles. Due to this effect, even when the polar organic solvent is removed from the second magnetic fluid for storage or safety reasons, the magnetic fluid obtained by adding the polar organic solvent again does not deteriorate. Therefore, the magnetic fluid according to this embodiment can solve the problems of storage and safety that have been encountered in the past.

The components contained in the first magnetic fluid and the second magnetic fluid will be described below.

### (First Magnetic Fluid)

The magnetic particles having an average particle size of 10 to 50 nm, and the saturated fatty acid or the salt thereof, or the unsaturated fatty acid or the salt thereof, having 10 to 24 carbon atoms contained in the first magnetic fluid are the same as those described in the magnetic material of this embodiment above.

The first magnetic fluid further contains water or a non-polar solvent. The water or non-polar solvent is added as a dispersion media for the magnetic particles contained in the magnetic fluid. Examples of non-polar solvents include aromatic hydrocarbons and aliphatic hydrocarbons. Examples of aromatic hydrocarbons include benzene, toluene, and xylene. Examples of aliphatic hydrocarbons include isoparaffin, kerosene, hexane, and heptane. The water or non-polar solvent may be used alone or in combination. When water is used as a dispersion media, it is preferable to further add a hydrophilic dispersant.

The content of the magnetic particles is preferably in the range of 25 to 70% by mass, and more preferably 28 to 60% by mass, relative to the total amount of the first magnetic fluid. By setting the content of the magnetic particles in the range of 25 to 70% by mass, relative to the total amount of the first magnetic fluid, the dispersibility of the magnetic particles can be maintained, so that the function as a fluid can be maintained and the first magnetic fluid can function as a magnetic material when a magnetic field is applied.

### (Second Magnetic Fluid)

The magnetic particles having an average particle size of 10 to 50 nm, the saturated fatty acid or the salt thereof, or the unsaturated fatty acid or the salt thereof, having 10 to 24 carbon atoms, and the alkoxylate formed by addition of an alkylene oxide having 2 to 4 carbon atoms to an alcohol having 1 to 3 carbon atoms contained in the second magnetic fluid are the same as those described in the magnetic material of this embodiment above. The content of the magnetic particles may be adjusted as appropriate depending on the intended use of the second magnetic fluid. A second magnetic fluid with an extremely low content of magnetic particles is called a standard sample for particle size distribution measurement. The content of magnetic particles in the standard sample for particle size distribution measurement will be described later. The content of magnetic particles in the second magnetic fluid (excluding the content of magnetic particles in the standard sample for particle size distribution measurement) is preferably in the same range as the content of magnetic particles in the first magnetic fluid.

### (Polar Organic Solvents)

The magnetic fluid (second magnetic fluid) according to this embodiment contains a polar organic solvent. The polar organic solvent is added as a dispersion media for the magnetic particles contained in the magnetic fluid. Examples of polar organic solvents include alcohols such as methanol, ethanol, and propanol, cresol, N,N-dimethylacetamide (DMAc), N-methyl-2-pyrrolidinone (NMP), dimethyl sulfoxide (DMSO), 1,3-dimethyl-imidazolidinone (DMI), N,N-dimethylformamide (DMF), butyl cellosolve (BCS), and γ-butyrolactone (GBL). One type of polar organic solvent may be used alone, or two or more types may be used in combination. Of these, alcohols are particularly preferred.

### (Other Components)

In addition to the components described above, the magnetic fluid of this embodiment may further contain various other components depending on the purpose, as long as the effects of this embodiment are not impaired.

Examples of other components include viscosity index improvers, surfactants, viscosity modifiers, rust inhibitors, antioxidants, corrosion inhibitors, metal deactivators, and antifoaming agents.

Examples of viscosity modifiers include polybutene, poly-alpha olefins, castor oil, hydrogenated castor oil, fatty acid amides, beeswax, carnauba wax, benlysine sorbitol, metal soaps, polyethylene oxide, sulfate ester-based anionic activators, (meth)acrylic esters, polyisobutylene, and polyalkylstyrenes.

One type of viscosity modifier may be used alone, or two or more types may be used in combination.

### (Applications)

The magnetic fluid of this embodiment can be used in a variety of applications that have traditionally been used. For example, it can be used in electronic devices such as speakers, vibration motors, and mobile devices that use these devices.

The magnetic fluid of this embodiment can also be used as a magnetic fluid seal. Examples of magnetic fluid seals include vacuum seals, dust seals, and gas seals.

Machinery that uses magnetic fluid seals include low-pressure CVD (LPCVD) equipment, roll coaters, spin chucks, turntables, substrate transfer robots, ion implanters, vacuum heat treatment equipment, and silicon pull-up equipment.

Furthermore, the magnetic fluid of this embodiment has the property of effectively suppressing secondary particles of magnetic particles in the magnetic fluid, even when the polar solvent in the magnetic fluid is removed and then added again to form a magnetic fluid. Therefore, it can be used as a standard sample for particle size distribution measurement.

### (Methods for Producing First Magnetic Fluid and Second Magnetic Fluid)

### 1. Method for Producing First Magnetic Fluid

The first magnetic fluid according to this embodiment can be produced by adding magnetic particles and the saturated fatty acid or the salt thereof, or the unsaturated fatty acid or the salt thereof, having 10 to 24 carbon atoms, and dispersing the mixture in water or a non-polar solvent.

The first magnetic fluid may be prepared or a commercially available product may be used.

### 2. Method for Producing Second Magnetic Fluid

A method for producing the second magnetic fluid according to this embodiment will now be described. Note that the magnetic fluid may be heated, cooled, or pressurized as needed during production.

First, an alkoxylate formed by addition of an alkylene oxide having 2 to 4 carbon atoms to an alcohol having 1 to 3 carbon atoms is mixed with the first magnetic fluid.

The first magnetic fluid can be prepared by a method of subdividing macroscopic magnetic particles to colloidal size or by condensing atoms or ions to obtain magnetic microparticles. Methods for subdividing magnetic particles include grinding and spark erosion. Methods for condensing atoms or ions include chemical coprecipitation (wet method), thermal decomposition of metal carbonyls, and vacuum deposition. Chemical coprecipitation is particularly preferred due to its superior productivity. For example, sodium oleate, a saturated fatty acid or a salt thereof, or an unsaturated fatty acid or a salt thereof, having 10 to 24 carbon atoms, is first added to a magnetite aqueous slurry prepared from an aqueous ferrous sulfate solution and an aqueous ferric sulfate solution, and oleate ions are attached to the surface of the magnetite particles to form particles. This produces the first magnetic fluid.

The alkoxylate formed by addition of an alkylene oxide having 2 to 4 carbon atoms to an alcohol having 1 to 3 carbon atoms can be produced by reacting alcohols having 1 to 3 carbon atoms with alkylene oxides having 2 to 4 carbon atoms using a basic catalyst.

Examples of the basic catalyst include alkali metal hydroxides, alkaline earth metal hydroxides, alkali metal hydrides, alkaline earth metal hydrides, alkali metal carboxylates, and/or alkaline earth metal carboxylates. The alkali metal is selected from the group consisting of Li, Na, K, Rb, and Cs, and the alkaline earth metal is selected from the group consisting of Be, Ca, Mg, Sr, and Ba.

Alternatively, an organic basic catalyst (e.g., an amine) may be used as the basic catalyst. Examples of the organic basic catalyst include aliphatic amines or alkanolamines such as N, N-dimethylbenzylamine, dimethylaminoethanol, dimethylaminopropanol, N-methyldiethanolamine, trimethylamine, triethylamine, N,N-dimethylcyclohexylamine, N-methylpyrrolidine, N, N,N′, N′-tetramethylethylenediamine, diazabicyclo[2.2.2]octane, 1,4-dimethylpiperazine, and N-methylmorpholine; aromatic amines such as imidazole and alkyl-substituted imidazole derivatives; N,N-dimethylaniline; 4-(N,N-dimethyl)aminopyridine; and partially crosslinked copolymers of 4-vinylpyridine or vinylimidazole with divinylbenzene.

As the alkali metal hydroxide, sodium hydroxide, potassium hydroxide and/or cesium hydroxide are preferred, and potassium hydroxide is particularly preferred.

An active hydrogen-containing organic compound and an alkylene oxide are placed in a reactor together with a basic catalyst and reacted in an inert gas atmosphere at a temperature of 80 to 180° C., preferably 100 to 170° C. This produces the alkoxylate formed by addition of an alkylene oxide having 2 to 4 carbon atoms to an alcohol having 1 to 3 carbon atoms.

As described above, the first magnetic fluid is mixed with the alkoxylate formed by addition of an alkylene oxide having 2 to 4 carbon atoms to an alcohol having 1 to 3 carbon atoms is added to an alcohol having 1 to 3 carbon atoms, and then the dispersion media (water or a non-polar solvent) contained in the first magnetic fluid is removed to obtain a magnetic material. Next, the polar organic solvent is mixed with the magnetic material to obtain the second magnetic fluid according to this embodiment.

### (Standard Sample for Particle Size Distribution Measurement)

The standard sample for particle size distribution measurement according to this embodiment includes a magnetic material according to this embodiment, which comprises magnetic particles having an average particle size of 10 to 50 nm, a saturated fatty acid or a salt thereof, or an unsaturated fatty acid or a salt thereof, having 10 to 24 carbon atoms, and an alkoxylate formed by addition of an alkylene oxide having 2 to 4 carbon atoms to an alcohol having 1 to 3 carbon atoms, and a polar organic solvent. The magnetic particles having an average particle size of 10 to 50 nm, the saturated fatty acid or the salt thereof, or the unsaturated fatty acid or the salt thereof, having 10 to 24 carbon atoms, and the alkoxylate formed by addition of the alkylene oxide having 2 to 4 carbon atoms to the alcohol having 1 to 3 carbon atoms, and the polar organic solvent, which are contained in the standard sample for particle size distribution measurement, can be the same as those used in the magnetic fluid according to the present embodiment described above.

The content of magnetic particles in the standard sample for particle size distribution measurement according to this embodiment is preferably 0.5 to 3 mass %, more preferably 1 to 1.8 mass %, and even more preferably 1 to 1.4 mass %.

When the magnetic fluid is used as a standard sample for particle size distribution measurement, the content of the polar organic solvent is preferably 97 to 99.5 mass %, and more preferably 98 to 99 mass %, relative to the total amount of the magnetic fluid.

The standard sample for particle size distribution measurement according to this embodiment can be used as a standard sample that serves as a basis for size calibration in measuring the particle size distribution of magnetic particles. The standard sample for particle size distribution measurement according to this embodiment can be prepared by blending a polar organic solvent with the magnetic material according to this embodiment, as described above. This solves problems with the storage and safety of magnetic fluids, and effectively suppresses the generation of secondary particles of magnetic particles in magnetic fluids, even when a polar organic solvent is added again to the magnetic material to create a magnetic fluid. This makes it an excellent standard sample for particle size distribution measurements.

### EXAMPLES

Examples of the present invention are shown below, but these examples are provided to provide a better understanding of the present invention and its advantages, and are not intended to limit the invention. In the following, unless otherwise specified, “%” represents “% by mass.”

The raw materials used in the examples and comparative examples are as follows.

### [First Magnetic Fluid 1]

Magnetic particles: magnetite (average particle size: 30 nm), a saturated fatty acid or a salt thereof, or an unsaturated fatty acid or a salt thereof, having 10 to 24 carbon atoms: sodium oleate, dispersion media: heptane, magnetic particle content: 50% by mass

### [First Magnetic Fluid 2]

Magnetic particles: magnetite (average particle size: 30 nm), a saturated fatty acid or a salt thereof, or an unsaturated fatty acid or a salt thereof, having 10 to 24 carbon atoms: sodium oleate, dispersion media: isoparaffin, magnetic particle content: 60% by mass

### [Magnetic Particles]

Magnetic particles: magnetite (average particle size: 20 nm), a saturated fatty acid or a salt thereof, or an unsaturated fatty acid or a salt thereof, having 10 to 24 carbon atoms: sodium oleate

### [Alkoxylate 1]

Alkoxylates formed by the addition of ethylene oxide to methanol: The alcohol has 1 carbon atom.

### [Alkoxylate 2]

Alkoxylates formed by the addition of ethylene oxide or propylene oxide to 1-hexadecanol or stearyl alcohol: The alcohol has 16 or 18 carbon atoms.

### [Alkoxylate 3]

Alkoxylates formed by the addition of ethylene oxide to 2-butyl-1-n-octanol: The alcohol has 12 carbon atoms.

### [Alkoxylate 4]

Alkoxylates formed by the addition of ethylene oxide to isotridecanol: The alcohol has 13 carbon atoms.

### [Polyester-Based Dispersant 1]

Polyhydroxystearic acid dispersant

### [Polyester-Based Dispersant 2]

Polycaprolactone dispersant

### [Polar Organic Solvents]

Ethanol

### Example 1

### 1. Preparation of First Magnetic Fluid 1

A magnetite aqueous slurry was produced using a known chemical coprecipitation method.

3N (normal) HClaq (hydrochloric acid aqueous solution) was added to this magnetite aqueous slurry to adjust its pH to 3, and then sodium oleate was added as a dispersant and stirred at 60° C. for 30 minutes. This process allowed the dispersant to adsorb to the surface of the magnetite microparticles. The solution was then left to stand, allowing the magnetite microparticles in the solution to coagulate and settle, and the supernatant was discarded. Fresh water was then added, stirred, and allowed to stand, and the supernatant was discarded. This water washing process was repeated several times to remove electrolytes from the aqueous solution, followed by filtration, dehydration, and drying, yielding powdered magnetite microparticles whose surfaces were coated with the dispersant sodium oleate.

Next, hexane, a low-boiling organic solvent, was added to the powdered magnetite microparticles and the mixture was thoroughly shaken to obtain an intermediate medium in which the magnetite microparticles were dispersed in hexane. Next, methanol, a low-boiling polar organic solvent, was added to the slurry, and the particles were once coagulated and precipitated, and the supernatant was discarded. This removed excess dispersant other than the dispersant monomolecularly adsorbed on the magnetite microparticles. The precipitated magnetite microparticles were then dispersed again in hexane to obtain an intermediate medium containing dispersed magnetite particles.

This intermediate medium was centrifuged in a centrifuge at a centrifugal force of 8000 G for 30 minutes, and relatively large particles with poor dispersibility among the magnetite dispersion particles were precipitated and removed. Next, the supernatant liquid containing the remaining magnetite microparticles that did not precipitate was transferred to a rotary evaporator, and kept at 90° C. to evaporate and remove the low-boiling organic solvent component, i.e., hexane, to obtain lipophilic magnetite microparticles (average particle size: 20 nm) whose surfaces were coated by monomolecular adsorption of the dispersant sodium oleate. The mass ratio of magnetite to sodium oleate was 4:1.

6.5 g of these magnetite microparticles were collected and redispersed in 6.5 g of heptane to obtain a first magnetic fluid 1.

### 2. Preparation of the Magnetic Material of Example 1

Next, 5 g of alkoxylate 1 was added to 10 g of this magnetic material, and the mixture was dried under reduced pressure to remove the heptane, yielding the magnetic material of Example 1.

### Example 2

The magnetic material of Example 2 was obtained in the same manner as in Example 1, except that the first magnetic fluid 1 in Example 1 was prepared using isoparaffin instead of heptane, and the amount added was changed to 4.3 g.

### Example 3

The magnetic material of Example 3 was obtained in the same manner as Example 1, except that the first magnetic fluid 2 was used instead of the first magnetic fluid 1.

### Comparative Example 1

The first magnetic fluid 1 in Example 1 was dried under reduced pressure to remove the heptane, yielding the magnetic material of Comparative Example 1.

### Comparative Example 2

A magnetic material of Comparative Example 2 was obtained in the same manner as in Example 1, except that alkoxylate 1 in Example 1 was changed to alkoxylate 2.

### Comparative Example 3

A magnetic material of Comparative Example 3 was obtained in the same manner as in Example 1, except that alkoxylate 1 in Example 1 was changed to alkoxylate 3.

### Comparative Example 4

A magnetic material of Comparative Example 4 was obtained in the same manner as in Example 1, except that alkoxylate 1 in Example 1 was changed to alkoxylate 4.

### Comparative Example 5

A magnetic material of Comparative Example 5 was obtained in the same manner as in Example 1, except that alkoxylate 1 in Example 1 was changed to polyester-based dispersant 1.

### Comparative Example 6

A magnetic material of Comparative Example 6 was obtained in the same manner as in Example 1, except that the alkoxylate 1 in Example 1 was changed to the polyester-based dispersant 2.

### Comparative Example 7

A magnetic material of Comparative Example 7 was obtained in the same manner as in Example 3, except that alkoxylate 1 in Example 3 was changed to alkoxylate 2.

### Example 4

Ethanol was added to the magnetic material of Example 1 to obtain a second magnetic fluid 1 having a magnetic particle content of 30 mass %.

### Example 5

Ethanol was added to the magnetic material of Example 3 to obtain a second magnetic fluid 2 having a magnetic particle content of 30 mass %.

### Comparative Example 8

An attempt was made to prepare a magnetic fluid by adding ethanol to the magnetic material of Comparative Example 2.

### Comparative Example 9

An attempt was made to prepare a magnetic fluid by adding ethanol to the magnetic material of Comparative Example 3.

### Comparative Example 10

An attempt was made to prepare a magnetic fluid by adding ethanol to the magnetic material of Comparative Example 4.

### Comparative Example 11

An attempt was made to prepare a magnetic fluid by adding ethanol to the magnetic material of Comparative Example 5.

### Comparative Example 12

An attempt was made to prepare a magnetic fluid by adding ethanol to the magnetic material of Comparative Example 6.

### Comparative Example 13

An attempt was made to prepare a magnetic fluid by adding ethanol to the magnetic material of Comparative Example 7.

### Example 6

A composition was obtained by removing ethanol from the magnetic fluid of Example 4. Ethanol was added to this composition to obtain a second magnetic fluid 3 having a magnetic particle content of 30 mass %.

### Example 7

Ethanol was added to the magnetic material of Example 1 to obtain a standard sample for particle size distribution measurement 1 having a magnetic particle content of 1% by mass.

### Comparative Example 14

Ethanol was added to the magnetic material of Comparative Example 1 to obtain a standard sample for particle size distribution measurement 2 having a magnetic particle content of 1% by mass.

### <Evaluation of Magnetic Material Condition>

The conditions of the magnetic materials in Examples 1-3 and Comparative Examples 1-7 were visually observed and evaluated using the following criteria A through D. The evaluation results are shown in Table 1.
A: Paste-like (fluid)
B: Clay-like (non-fluid)
C: Liquid
D: Solid-liquid separated

### <Evaluation of Superparamagnetic Properties>

10 g of each of the second magnetic fluids from Examples 4-6 and the compositions from Comparative Examples 8-13 were placed in a Petri dish. A permanent magnet (240 mT×6 stacked neodymium magnets) was brought close to the glass surface of the Petri dish, and the presence or absence of spikes was visually evaluated. The evaluation criteria were as follows. The evaluation results are shown in Table 2.

The presence of spikes indicates that the magnetic particles in the second magnetic fluid possess superparamagnetic properties.
A: Spikes present
B: No spikes present

### <Evaluation of Dispersibility in Polar Organic Solvents>

The conditions of the second magnetic fluids of Examples 4-6 and the compositions of Comparative Examples 8-13 were visually evaluated. The evaluation criteria are as follows. The evaluation results are shown in Table 2.
A: A magnetic fluid was formed, and the magnetic particles were dispersed in ethanol.
B: A magnetic fluid was not formed, and the magnetic material and ethanol separated.

### <Evaluation of Magnetic Particle Size>

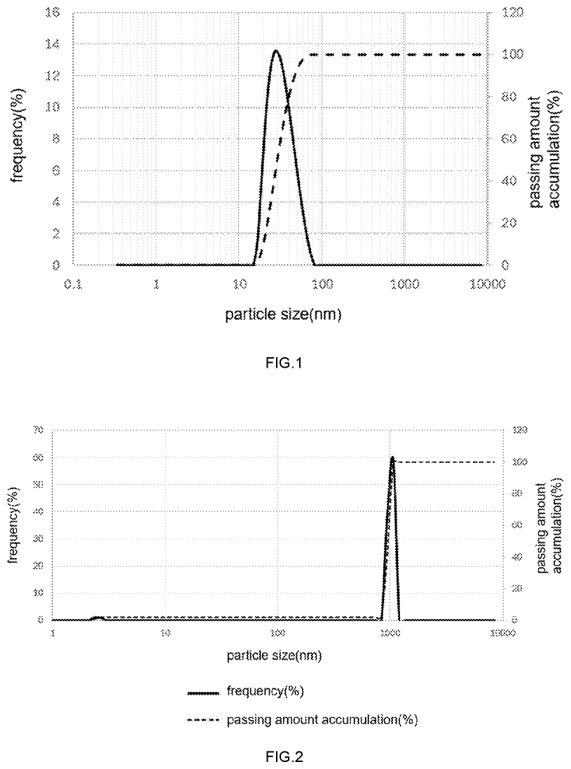

The particle size distribution measurement results for the magnetic particles in the standard sample for particle size distribution measurement of Example 7 and the standard sample for particle size distribution measurement of Comparative Example 14 are shown in FIGS. 1 and 2. Particle size measurements were performed using a dynamic light scattering particle size distribution analyzer (product name: SZ-100SZ, manufactured by HORIBA, Ltd.).

As shown in FIG. 1, the particle size distribution peak of the magnetic particles in the standard sample for particle size distribution measurement of Example 7 was approximately 30 nm.

TABLE 1

| | Example | | | Comparative Example | | | | | | |
|---|---|---|---|---|---|---|---|---|---|---|
| | 1 | 2 | 3 | 1 | 2 | 3 | 4 | 5 | 6 | 7 |
| Condition | A | A | A | B | B | C | C | C | C | B |
| evaluation | | | | | | | | | | |
| of | | | | | | | | | | |
| magnetic | | | | | | | | | | |
| materials | | | | | | | | | | |

TABLE 2

| | Example | | | Comparative Example | | | | | |
|---|---|---|---|---|---|---|---|---|---|
| | 4 | 5 | 6 | 8 | 9 | 10 | 11 | 12 | 13 |
| Condition | A | A | A | B | B | B | B | B | B |
| evaluation | | | | | | | | | |
| of magnetic | | | | | | | | | |
| materials | | | | | | | | | |
| Dispersibility | A | A | A | B | B | B | B | B | B |
| evaluation in | | | | | | | | | |
| polar organic | | | | | | | | | |
| solvents | | | | | | | | | |

### DISCUSSION

The magnetic materials of Examples 1 to 3 contained magnetic particles having an average particle size of 10 to 50 nm, a saturated fatty acid or a salt thereof, or an unsaturated fatty acid or a salt thereof, having 10 to 24 carbon atoms, and an alkoxylate formed by addition of an alkylene oxide having 2 to 4 carbon atoms to an alcohol having 1 to 3 carbon atoms. As a result, all of these magnetic materials were in a fluid, paste-like form, as shown in Table 1.

In contrast, the magnetic materials of Comparative Examples 1 to 7 did not contain a saturated fatty acid or a salt thereof, or an unsaturated fatty acid or a salt thereof, having 10 to 24 carbon atoms or an alkoxylate formed by addition of an alkylene oxide having 2 to 4 carbon atoms to an alcohol having 1 to 3 carbon atoms. As a result, none of these magnetic materials were in a fluid, paste-like form, as shown in Table 1.

The second magnetic materials of Examples 4 to 6 were obtained by adding a polar organic solvent to the magnetic materials of Examples 1 to 3, and as shown in Table 2, they possessed superparamagnetic properties and had good dispersibility in polar organic solvents.

On the other hand, the compositions of Comparative Examples 8 to 13 were obtained by adding a polar organic solvent to the magnetic materials of Comparative Examples 2 to 7, and as shown in Table 2, they did not possess superparamagnetic properties and did not form magnetic fluids; they separated into the magnetic material and ethanol and did not form magnetic fluids.

The results of Examples 1 to 7 show that the particle diameters of the magnetic particles in first magnetic fluid 1 and first magnetic fluid 2 were both 20 nm, while the peak of particle size distribution of the magnetic particles in standard sample for particle size distribution measurement 1 was approximately 30 nm. Therefore, this difference in particle diameter can be attributed to an adhesion of the second surfactant to the first surfactant.

In other words, the results of Examples 1 to 7 show that by including a second surfactant in the magnetic material, which is an alkoxylate formed by addition of an alkylene oxide having 2 to 4 carbon atoms to an alcohol having 1 to 3 carbon atoms, the second surfactant adheres to the first surfactant that is adhered to the surface of the magnetic particles, solving problems with the storage and safety of the magnetic fluid and effectively suppressing aggregation of the magnetic particles in the magnetic fluid, even when a polar organic solvent is added again to the magnetic material to create a magnetic fluid.

1. A magnetic material comprising:
magnetic particles having an average particle size of 10 to 50 nm,
a saturated fatty acid or a salt thereof, or an unsaturated fatty acid or a salt thereof, having 10 to 24 carbon atoms, and
an alkoxylate formed by addition of an alkylene oxide having 2 to 4 carbon atoms to an alcohol having 1 to 3 carbon atoms.

2. The magnetic material according to claim 1, being in paste form.

3. A magnetic fluid comprising:
the magnetic material according to claim 1, and
a polar organic solvent.

4. A standard sample for particle size distribution measurement, comprising:
the magnetic material according to claim 1, and
a polar organic solvent,
wherein a content of the magnetic particles is 0.5 to 3 mass %.

5. A method for producing a magnetic material, comprising:
removing the polar organic solvent from the magnetic fluid according to claim 3 to obtain a magnetic material,
wherein a content of the polar organic solvent in the magnetic material obtained after removing the polar organic solvent is 1 mass % or less.

6. A method for producing a magnetic material, comprising:
obtaining a first magnetic fluid containing magnetic particles, a saturated fatty acid or a salt thereof, or an unsaturated fatty acid or a salt thereof, having 10 to 24 carbon atoms, and water or a non-polar solvent,
mixing an alkoxylate formed by addition of an alkylene oxide having 2 to 4 carbon atoms to an alcohol having 1 to 3 carbon atoms with the first magnetic fluid, and
removing the water or the non-polar solvent.

7. A method for producing a magnetic fluid, comprising:
mixing a polar organic solvent with the magnetic material obtained by the production method according to claim 6 to obtain a second magnetic fluid.
